(19) United States
(12) Patent Application Publication
(10) Pub. No.: US 2007/0078881 A1
(43) Pub. Date: Apr. 5, 2007

(54) Table columns organizer

(75) Inventor: Peter Vignet, San Francisco, CA (US)

Correspondence Address: HOLLAND & KNIGHT, LLP, 10 ST. JAMES AVENUE, BOSTON, MA, 02116, US

(73) Assignee: SAP AG, Walldorf (DE)

(21) Appl. No.: 11/242,250

(22) Filed: Oct. 3, 2005

(51) Int. Cl. G06F 7/00

(52) U.S. Cl. 707/102

(57) ABSTRACT

Methods and apparatus, including computer program products, for a table columns organizer. A method of displaying information on a display device of a computer system includes loading data into a table node data structure memory, the table node data structure including node elements and attributes, displaying a first view on the display device, the first view including column organizing functions and the data arranged in a first table of rows and columns received from the table node data structure, activating a first set of selected column organizing functions, and displaying a second view on the display device, the second view including the objects arranged as a second table of rows and columns in response to the first set of selected column organizing functions in the first view.

### BACKGROUND

The present invention relates to data processing by digital computer, and more particularly to a table columns organizer.

A table having rows and columns can be displayed on a computer display device. Data pertaining to a specific topic may be displayed in the table, for example, with database objects, or records, in different rows of the table and selected fields for objects in columns. Tables can contain a small number of database objects (for example, less than five), or a very large number (hundreds, thousands, or more). As such, a method to organize and display particular objects of interest to a user becomes especially desirable when dealing with large tables.

### SUMMARY

The present invention provides methods and apparatus, including computer program products, for a table columns organizer.

In general, in one aspect, the invention features a computer-implemented method of displaying information on a display device of a computer system including loading data into a table node data structure stored in a memory, the table node data structure including node elements and attributes, displaying a first view on the display device, the first view including column organizing functions and the data arranged in a first table of rows and columns received from the table node data structure, activating a first set of selected column organizing functions, and displaying a second view on the display device, the second view including the objects arranged as a second table of rows and columns in response to the first set of selected column organizing functions in the first view.

In embodiments, the column organizing functions can be selected from a group consisting of a visibility function, a table position function, a sequence sorting order function and a filtering range function. The first view can keep track of the columns using a context node data structure stored in the memory, the context node including status and requirements for each column including an original status of selected column organizing functions. Activating selected column functions can include receiving an input from a user.

The method can include activating a second set of selected column organizing functions, and displaying a third view on the display device, the third view including objects arranged as a third table of rows and columns in response to the second set of selected column organizing functions. The method can include receiving a reset command, and redisplaying the second view.

Other features and advantages of the invention are apparent from the following description, and from the claims.

### BRIEF DESCRIPTION OF THE DRAWINGS

FIG. 1 is a block diagram of an exemplary system.

FIG. 2 is a block diagram of user interface (UI).

FIG. 3 is a block diagram of a UI.

FIG. 4 is a block diagram of a UI.

FIG. 5 is a block diagram of a UI.

FIG. 6 is a block diagram of a UI.

FIG. 7 is a flow diagram.

Like reference numbers and designations in the various drawings indicate like

### DETAILED DESCRIPTION

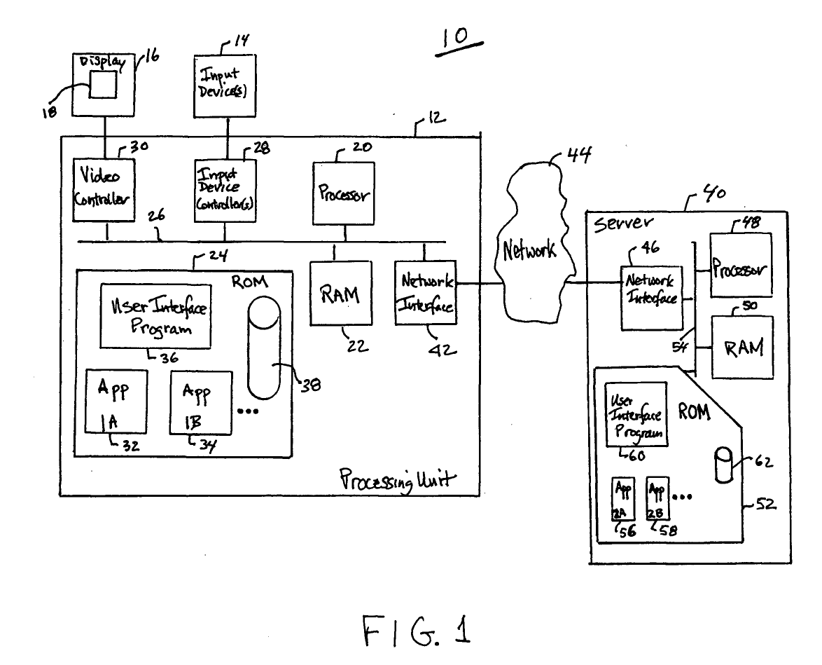

As shown in FIG. 1, an exemplary computer system 10 includes a processing unit 12, one or more input devices 14, and a display device 16, upon which a user is presented displays. The display device 16 has a video screen 18 upon which displays appear.

The processing unit 12 can include a processor 20, random access memory (RAM) 22, and read-only memory (ROM) 24, all interconnected by a data bus 26. Input device controllers 28, also connected to the data bus 26, receive command signals from input devices 14 and forward the command signals in the appropriate format for processing. A video controller 30, connected to the data bus 26, receives video command signals from the data bus 26 and generates the appropriate video signals that are forwarded to the display device 16 so that the desired display is provided on the screen 18. The system 10 is not limited to a personal computer (PC), but could include a personal digital assistant (PDA), a terminal, a workstation, or other such device.

ROM 24 provides non-volatile data storage for various application programs. In the example shown, a number of different application programs 32, 34, are stored in ROM 24. Also stored in ROM 24 is a user interface (UI) program 36 designed to work in concert with each of the application programs 32, 34. This is conceptually depicted by the UI program 36 shown as a layer on top of the application programs 32, 34. With such a design, UI program modules common to several application programs need not be duplicated in each of the application programs 32, 34. In addition, such a design may enable a common “look-and-feel” to the UI for the different program applications 32, 34. In other examples, the UI program, or module, is not a common program or module for more than one program application. In still other examples, the components described can be combined or separated in various manners, and can be stored in various manners, such as on various non-volatile storage medium.

Programs 32, 34, 36 have program instructions that can be loaded into RAM 22 during operation. Processor 20 then executes the program instructions, as required, to perform desired program functions.

Also stored in ROM 24 are various data in database 38. Database 38 includes data needed or generated during operation of the application programs 32, 34. Although only a single database 38 is shown that serves as a common database for all applications 32, 34, in other examples there can be separate databases for one, or more, of the applications 32, 34.

System 10 includes connection to a server 40 and a network interface 42, connected to its data bus 26. As such, system 10 can access server 40 over network 44 to run applications residing on the server 40. Network 44 can be, for example, a Local Area Network (LAN), Wide Area Network (WAN), or the Internet.

The server 40 includes a network interface 46, a processor 48, RAM 50, and ROM 52, all interconnected by a data bus 54. The server's network interface 46 provides the connection to network 44 so that client computer systems, such as system 10, can access the server 40. In similar fashion to computer system 10, the server ROM 52 includes various different application programs 56, 58, as well as a common user interface program 60 for the application programs 56, 58. ROM 52, in this example, includes data stored in database 62, although in other implementations separate databases or a separate database server may be required.

Web Dynpro from SAP AG is an integral part of a SAP Web Application that provides a design-time environment that is independent of the underlying runtime environment and enables companies to model and design user interfaces (UIs) cost-effectively and precisely. A Web Dynpro application includes a set of views, navigation between the views, concepts for managing the views and determining their sequence, a context for keeping session data, and the business logic of the application.

As an example, a table displayed on a UI is described using Web Dynpro from SAP AG. However, the methods described can be used in other UIs generated by other application programs. Version 4 of SAP's xRPM (Resource Planning Management) is called xPPM (Portfolio Planning Management) and uses Web Dynpro. Web Dynpro is built on the concept of Model View Controller (MVC). A model is any layer of code that encapsulates some business functionality external to the Web Dynpro component. A model provides access to functionality such as business application programming interface (BAPI) calls or Web Services and can be implemented as, for example, a set of proxy objects, Enterprise Javabeans (EJB), and so forth.

A MVC is a design pattern often used by applications that need an ability to maintain multiple views of the same data. The MVC pattern hinges on a clean separation of objects into one of three categories, i.e., models for maintaining data, views for displaying all or a portion of the data, and controllers for handling events that affect the model or view(s). Because of this separation, multiple views and controllers can interface with the same model. Even new types of views and controllers that never existed before can interface with a model without forcing a change in the model design.

Events typically cause a controller to change a model, or view, or both. Whenever the controller changes a model's data or properties, all dependent views are automatically updated. Similarly, whenever the controller changes a view, for example, by revealing areas that were previously hidden, the view gets data from the underlying model to refresh itself.

A controller acts as the binding layer between the model and the view layers. They are three types of controllers, i.e., component controller, custom controller and view controller. A component controller is both a central point of control for all functionality found within a Web Dynpro component and is the only point of interface between the models and the view controller. A custom controller usably implements functionality that does not use a UI. The view controller is concerned with the display of some data of the component or custom controller.

A controller typically has two parts, a context and an implementation. A context is one hierarchical data storage structure for the controller. A context is composed of hierarchical arrangements of entities known as nodes and attributes. A node is permitted to have children, an attribute is not. An element of nodes is an aggregation of attributes of a node, or in other words, a node is a collection of elements. The implementation is a programmatic part that represents the business logic.

A view includes a set of UI elements than can both display application data and receive input. Web Dynpro enables design-oriented development of UIs and provides a comprehensive class library of UI elements for application programming.

UI elements can be used within a Web application to execute actions, display and enter text or display graphics. When developing Web Dynpro applications, the UI elements are placed in a view displayed in a specific screen area at runtime. Each UI element has different properties and events that determine the appearance and behavior of the UI element on the UI.

To represent a table for an end user, Web Dynpro uses a UI Web Dynpro Table. A UI Web Dynpro Table represents a two-dimensional data set arranged in rows and columns. UI Web Dynpro Table represents data from the view context. A table receives its data from a context node, i.e., the table property dataSource must be bound to a multiple context node. At runtime, each node element of the node collection is a table row. The number of table rows is identical to the number of node elements. The table columns correspond to the context attributes and are described by the aggregation of Table Column objects. They specify the number and order of columns as well as the headers and the width of the columns. Table Columns can be fixed at design time or added dynamically at run time.

SAP's Project Portfolio Management (PPM) is a business software application that entails balancing resources, business needs, business risks and changing parameters, while at the same time maximizing the return on (project) investment. A project portfolio is the sum of all projects and programs at an enterprise or business unit. PPM focuses on processes across multiple projects rather than processes within individual projects, and is typically based on iterative priorization, decision-making, and monitoring. An overriding objective is typically to ensure alignment with strategic objectives.

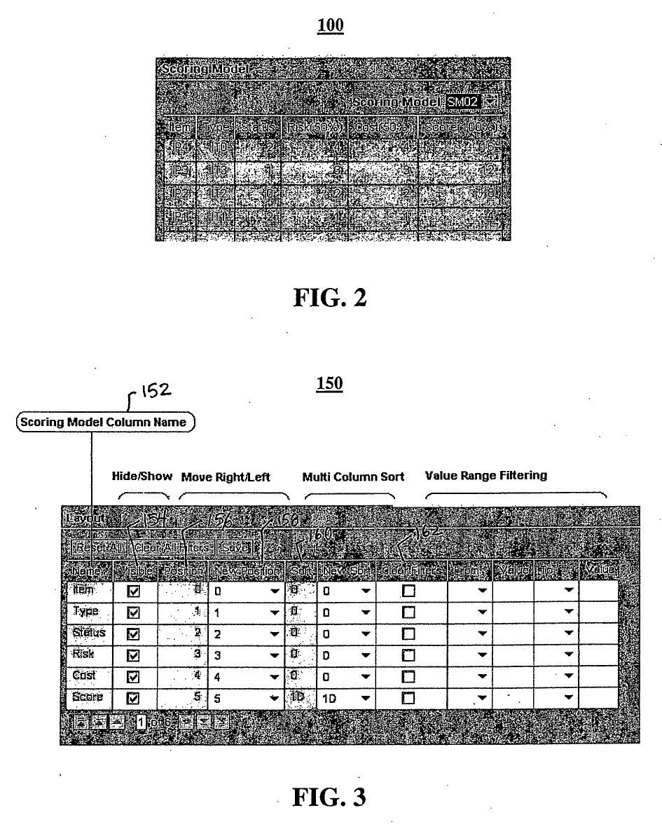

As shown in FIG. 2, SAP PPM defines a concept of a Scoring Model (SM02) 100. The Scoring Model 100 is a method used to compare all, or a subset of, portfolio items against each other according some selected common criteria called attributes. A portfolio item has these attributes. A portfolio item attribute has only a one value for per attribute. In this particular example, the scoring model SM02 has four items, i.e., IP1, IP2, IP3, IP4, and two criteria or attributes, i.e., Risk and Cost (both with a 50% weight). Here, items IP1, IP2, IP3, and IP4 are ranked by decreasing score.

Traditionally, a Web Dynpro Table and Web Dynpro Table Columns offer a limited number of actions on the columns. These actions are one action on the column header and a filtering action. The action on the column header is typically used for sorting the content of the column. The filtering action affects input occurring only in the first row.

The standard UI elements Table and Table Column do not offer functions such as hiding a column, moving a column right or left, sorting according to multiple columns (for example, sorting by Status, then Score, filtering a value range with =,>,>=,<,<=signs).

As shown in FIG. 3, an exemplary table column organizer UI 150 (also referred to as a layout) enables, for each column of a table, visibility, position in the table, ascending or descending sorting sequencing, filtering value ranges, and any additional column operations, such as, for example, making a column of a table a pivot column for pivoting the table on that column.

In the example shown, table column organizer UI 150 reflects the columns layout of the scoring model 100 (SM02). The first column has the Column Names of the Scoring Model table 152. The other columns contain specific actions that can be performed on the column names. In this example, the second column “Visible” 154 enables a user to show or hide the column in the scoring model. Currently all the columns are shown, as reflected by the check marks.

The “Position” column 156 indicates a current position of the column name in the scoring table model. In this example, the column names have a position from 0 to 5 and the column names are shown in this order in scoring model 100 and in the layout 150. The “New Position” column 158 enables a drop down to pick a new position that will be reflected after pushing a save button. The “Sort” column 160 enables multi-column sorting. A value of 0 indicates that there is no sorting on the column. The sorting can be for each column in ascending or descending order. In this example, the “Score” column in the last position is the only column that is involved in the sorting sequence. The “Score” column is done in descending order (i.e., 1 D). The remaining columns are for filtering. Currently, none of the columns have a filter. The first column of this filtering function is “Clear Filters” 162. Checking the check box in this column will clear (after saving) all the filter values for this column name.

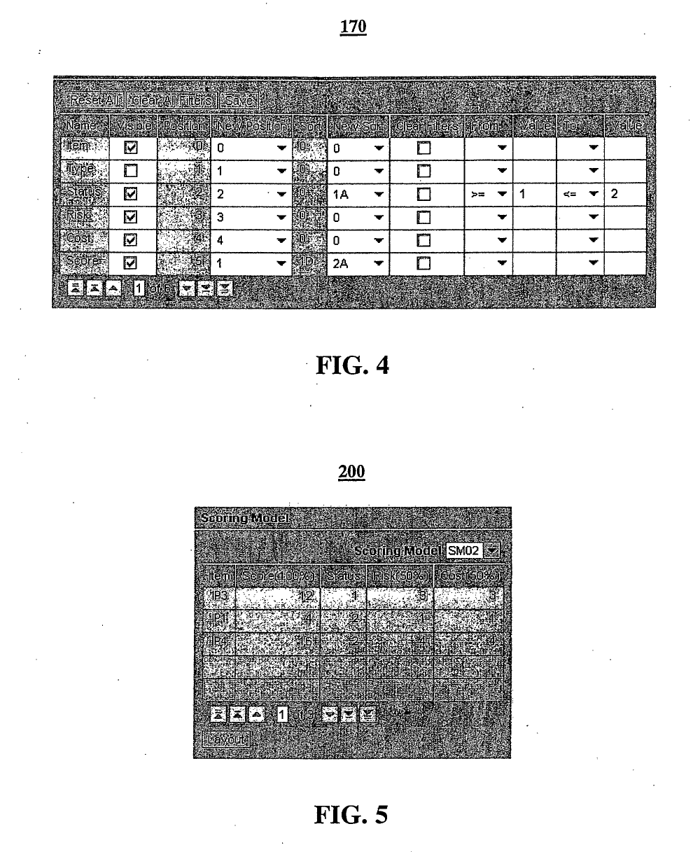

In another particular example, the user may want to hide the column “Type,” position the column “Score” just after the column “Item,” sort by ascending status first and then by ascending “score,” and filter for “Status >=1” and “Status <=2.” As shown in FIG. 4, UI 170 enables a user to accomplish this, employing the columns organizer. For “Type,” the user un-checks the “Visible” check box. For “Score,” the user sets the “New Position” to 1. For “Status,” the user sets the “New Sort” to 1A and for “Score” sets the “New Sort” to 2A. For “Status,” the sets “From” to >= and “Value” to 1; the user sets “To” to <= and “Value” to 2.

As shown in FIG. 5, after saving the previous actions, a scoring model table 200 is reflected. Here, the “Type” column is not visible. The “Score” column is positioned just after the “Item” column. The rows are sorted in ascending order of the “Status,” then in ascending order to the “Score.” Only rows with the “Status” >=1 and <=2 are shown.

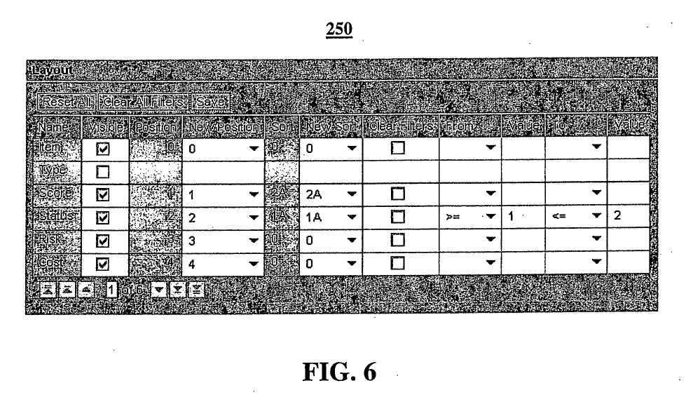

As shown in FIG. 6, a layout 250 reflects the new organization of the scoring model table 200. More specifically, row “Type” is disabled. “Score” is now after the row “Item” and its Position is 1. Row one's current “Sort” is 2A. “Status” is filtered for value range >=1 and <=2 and “Sort” sequence is 1A. Additional functional buttons on the top of the layout 250 allow a user to reset the layout to its original values, or to clear the entire value range filter.

A layout view reflects a context of the column organizer. Its context view keeps track of the status and requirements for each column using a context node, including the original status of each function (visible, sort, position, and filter) for every column of the scoring model. The scoring model table is built dynamically at run time according each column requirement keep in the column organizer view context. This enables avoiding a new back end system call for each new column requirements, consequently avoiding negative performance costs.

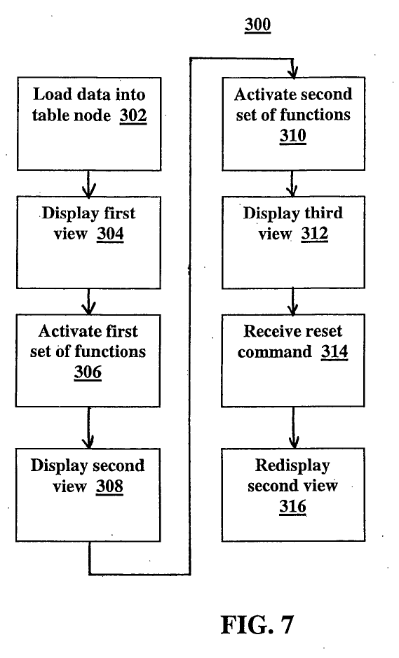

As shown in FIG. 7, a process 300 of displaying information on a display device of a computer includes loading (302) data into a table node data structure memory, the table node data structure including node elements and attributes. The process 300 displays (304) a first view on the display device, the first view including column organizing functions and the data arranged in a first table of rows and columns received from the table node data structure. The process 300 activates (306) a first set of selected column organizing functions. The process 300 displays (308) a second view on the display device, the second view including the objects arranged as a second table of rows and columns in response to the first set of selected column organizing functions in the first view.

Process 300 can include activating (310) a second set of selected column organizing functions, and displaying (312) a third view on the display device, the third view including objects arranged as a third table of rows and columns in response to the second set of selected column organizing functions.

Process 300 can include receiving (314) a reset command, and redisplaying (316) the second view.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method of displaying information on a display device of a computer system, the method comprising:
loading a plurality of data into a table node data structure memory, the table node data structure comprising a plurality of node elements and attributes, and
displaying a first view on the display device, the first view comprising column organizing functions and the plurality of data arranged in a first table of rows and columns received from the table node data structure;
activating a first set of selected column organizing functions; and
displaying a second view on the display device, the second view comprising the plurality of objects arranged as a second table of rows and columns in response to the first set of selected column organizing functions in the first view.

2. The computer-implemented method of claim 1 wherein the column organizing functions are selected from a group consisting of a visibility function, a table position function, a sequence sorting order function, a filtering range function, and column pivot functions.

3. The computer-implemented method of claim 1 wherein the first view keeps track of the columns using a context node data structure stored in the memory, the context node comprising status and requirements for each column including an original status of selected column organizing functions.

4. The computer-implemented method of claim 1 wherein activating selected column functions comprises receiving an input from a user.

5. The computer-implemented method of claim 1 further comprising:
activating a second set of selected column organizing functions; and
displaying a third view on the display device, the third view comprising the plurality of objects arranged as a third table of rows and columns in response to the second set of selected column organizing functions.

6. The computer-implemented method of claim 5 further comprising:
receiving a reset command; and
redisplaying the second view.

7. A computer program product, tangibly embodied in an information carrier, for displaying information on a computer display device, the computer program product being operable to cause data processing apparatus to:
load a plurality of data into a table node data structure memory, the table node data structure comprising a plurality of node elements and attributes, and
display a first view on the display device, the first view comprising column organizing functions and the plurality of data arranged in a first table of rows and columns received from the table node data structure;
activate a first set of selected column organizing functions; and
display a second view on the display device, the second view comprising the plurality of objects arranged as a second table of rows and columns in response to the first set of selected column organizing functions in the first view.

8. The computer program product of claim 7 wherein the column organizing functions are selected from a group consisting of a visibility function, a table position function, a sequence sorting order function and a filtering range function.

9. The computer program product of claim 7 wherein the first view keeps track of the columns using a context node data structure stored in the memory, the context node comprising status and requirements for each column including an original status of selected column organizing functions.

10. The computer program product of claim 7 wherein activating selected column functions comprises receiving an input from a user.

11. The computer program product of claim 7 further causing data processing apparatus to:
activate a second set of selected column organizing functions; and
display a third view on the display device, the third view comprising the plurality of objects arranged as a third table of rows and columns in response to the second set of selected column organizing functions.

12. The computer program product of claim 11 further causing data processing apparatus to:
receive a reset command; and
redisplay the second view.

13. A computer system comprising:
a display device;
a memory;
means for loading a plurality of data into a table node data structure memory, the table node data structure comprising a plurality of node elements and attributes, and
means for displaying a first view on the display device, the first view comprising column organizing functions and the plurality of data arranged in a first table of rows and columns received from the table node data structure;
means for activating a first set of selected column organizing functions; and
means for displaying a second view on the display device, the second view comprising the plurality of objects arranged as a second table of rows and columns in response to the first set of selected column organizing functions in the first view.

14. The system of claim 13 wherein the column organizing functions are selected from a group consisting of a visibility function, a table position function, a sequence sorting order function and a filtering range function.

15. The system of claim 13 wherein the first view keeps track of the columns using a context node data structure stored in the memory, the context node comprising status and requirements for each column including an original status of selected column organizing functions.

16. The system of claim 13 wherein means for activating selected column functions comprises receiving an input from a user.

17. The system of claim 13 further comprising:
means for activating a second set of selected column organizing functions; and
means for displaying a third view on the display device, the third view comprising the plurality of objects arranged as a third table of rows and columns in response to the second set of selected column organizing functions.

18. The system of claim 17 further comprising:
means for receiving a reset command; and
means redisplaying the second view.
